(19) United States
(12) Patent Application Publication
(10) Pub. No.: US 2020/0119322 A1
(43) Pub. Date: Apr. 16, 2020

(54) FILM WOUND BODY

(71) Applicant: UBE INDUSTRIES, LTD., Ube-shi (JP)

(72) Inventors: Hiroki NAGUMO, Osaka (JP); Shinji UYAMA, Osaka (JP); Yoshihisa KAKUTA, Osaka (JP)

(21) Appl. No.: 16/626,799

(22) PCT Filed: Jul. 2, 2018
(86) PCT No.: PCT/JP2018/025070

§ 371 Date: Dec. 26, 2019

(30) Foreign Application Priority Data
Jul. 3, 2017 (JP) 2017-130572

(51) Int. Cl. H01M 2/16; H01M 10/0587

(52) U.S. Cl. CPC H01M 2/162; H01M 10/0587

(57) ABSTRACT

A film wound body formed of: a cylindrical core; and a polyolefin microporous film which is wound around the core and used as a separator for a power storage device, in which a difference ΔR between a maximum outer diameter and a minimum outer diameter in a width direction is in a range of 0.05 to 1.2 mm.

### TECHNICAL FIELD

The present invention relates to a film wound body.

Priority is claimed on Japanese Patent Application No. 2017-130572, filed on Jul. 3, 2017, the content of which is incorporated herein by reference.

### BACKGROUND ART

In recent years, a power storage device such as a lithium secondary battery is widely used for power storage of a small electronic device such as a mobile phone or a note type personal computer, and an electric car. The lithium secondary battery includes a positive electrode, a negative electrode, a separator interposed between the positive electrode and the negative electrode, and a non-aqueous electrolyte formed of a lithium salt and a non-aqueous solvent.

In the related art, Patent Document 1 and Patent Document 2 disclose a film roll used for a separator of a lithium secondary battery.

Patent Document 1 discloses a manufacturing method of a porous polypropylene film roll, including unwinding a porous polypropylene film from a porous polypropylene film roll, performing an annealing treatment at a temperature in a range of 60° C. to 100° C. for a range of 10 to 120 seconds, and performing winding again. The porous polypropylene film obtained from the porous polypropylene film roll manufactured by the manufacturing method disclosed in Patent Document 1 has excellent flatness.

However, it was insufficient from a viewpoint of manufacturing cost, because the number of facilities and steps for performing the annealing treatment was increased.

Patent Document 2 discloses a microporous membrane wound body made of polyolefin in which a relational expression of 0.01≤(D²−d²)/L≤0.5 satisfies between a maximum outer diameter D, a minimum outer diameter d, and a winding length L. In the microporous membrane wound body made of polyolefin disclosed in Patent Document 2, a special elastically deformable metal roll is used in a case of manufacturing a membrane, and accordingly, workability is excellent in the manufacturing of a product such as a battery separator having excellent thickness stability. However, it was insufficient from a viewpoint of manufacturing cost, because the introduction of the special metal roll was necessary.

### CITATION LIST

### Patent Literature

[Patent Document 1] Japanese Unexamined Patent Application, First Publication No. 2014-177524
[Patent Document 2] Japanese Unexamined Patent Application, First Publication No. 2004-099799

### SUMMARY OF THE INVENTION

### Problems to be Solved by the Invention

However, in a separator roll, it is necessary to further decrease a slack amount of a porous film unwound from the separator roll. In a case where the slack amount of the unwound porous film is great, for example, winding properties and handling properties are insufficient, in a case of manufacturing a lithium secondary battery in which this is used as the separator.

In general, in a manufacturing method of a separator film, it is possible to provide a separator roll by slitting a separator mother roll around which a stretchable film is wound with a rewinder or the like, to have predetermined width and length. In order to decrease the slack amount of the porous film unwound from the separator roll, it is necessary to improve smoothness, in a state of the separator mother roll.

The present invention is made in view of such circumstances, and an object of the present invention is to provide a film wound body to which a porous film used as a separator for a power storage device is attached and in which the slack amount of the unwound porous film is small.

### Means to Solve the Problems

In order to achieve the object, the present inventors have focused on a strain of a polyolefin microporous film caused by unwinding the polyolefin microporous film from a separator roll and conducted intensive studies.

As a result, it was found that, as a difference ΔR between a maximum outer diameter and a minimum outer diameter in a width direction of a separator mother roll is decreased, the slack amount of the unwound polyolefin microporous film is decreased. It is assumed that this is because, by decreasing the ΔR of the separator mother roll, a tension applied to the polyolefin microporous film becomes more even, in a case of unwinding the separator film from the separator roll cut from the separator mother roll in the slitting step, and a strain of the polyolefin microporous film caused by the unwinding is reduced.

In addition, from the intensive studies, the inventors have found that, by setting the ΔR of the separator mother roll in a range of 0.05 to 1.2 mm, the slack amount of the polyolefin microporous film unwound from the separator roll cut from the separator mother roll in the slitting step is sufficiently decreased, and completed the present invention.

That is, the present invention has the following configurations.

(1) A film wound body formed of a cylindrical core, and a polyolefin microporous film which is wound around the core and used as a separator for a power storage device, in which a difference ΔR between a maximum outer diameter and a minimum outer diameter in a width direction is in a range of 0.05 to 1.2 mm.

(2) The film wound body according to (1), in which the polyolefin microporous film includes one or both of polypropylene and polyethylene.

(3) The film wound body according to (1) or (2), in which the polyolefin microporous film has a three-layer structure in which a polypropylene microporous membrane, a polyethylene microporous membrane, and a polypropylene microporous membrane are laminated in this order.

(4) The film wound body according to any one of (1) to (3), in which a compressive elastic modulus of the polyolefin microporous film is in a range of 95 MPa to 150 MPa.

(5) The film wound body according to any one of (2) to (4), in which the polyolefin microporous film includes polypropylene, and a weight average molecular weight of the polypropylene is equal to or greater than 500,000.

(6) The film wound body according to any one of (2) to (5), in which the polyolefin microporous film includes polypropylene, and a molecular weight distribution of the polypropylene is in a range of 9 to 13.

(7) The film wound body according to any one of (1) to (6), in which a total length of the polyolefin microporous film is equal to or greater than 2,000 m.

### Effects of the Invention

The film wound body of the present invention includes a separator mother roll and a separator roll obtained by cutting the separator mother roll.

In the film wound body of the present invention, the difference ΔR between the maximum outer diameter and the minimum outer diameter in the width direction is in a range of 0.05 to 1.2 mm. Accordingly, the slack amount of the polyolefin microporous film unwound from the film wound body is sufficiently small. Therefore, the polyolefin microporous film unwound from the film wound body of the present invention is suitable as a material of a separator for a power storage device.

Specifically, the polyolefin microporous film unwound from the film wound body of the present invention has suitable winding properties and handling properties, in a case of manufacturing a lithium secondary battery using this as a separator. Accordingly, it is possible to efficiently manufacture a lithium secondary battery, by using the polyolefin microporous film unwound from the film wound body of the present invention. In addition, since the slack amount of the polyolefin microporous film unwound from the film wound body of the present invention is small, the polyolefin microporous film unwound from the film wound body of the present invention is suitable as a separator of a stack type battery.

### BRIEF DESCRIPTION OF THE DRAWINGS

FIG. 1 is a schematic view for describing a film wound body of an embodiment.

FIG. 2 is a schematic cross-sectional view for describing an example of a polyolefin microporous film formed of a multilayer film.

### DESCRIPTION OF THE EMBODIMENTS

Hereinafter, a film wound body of the present invention will be described in detail with examples.

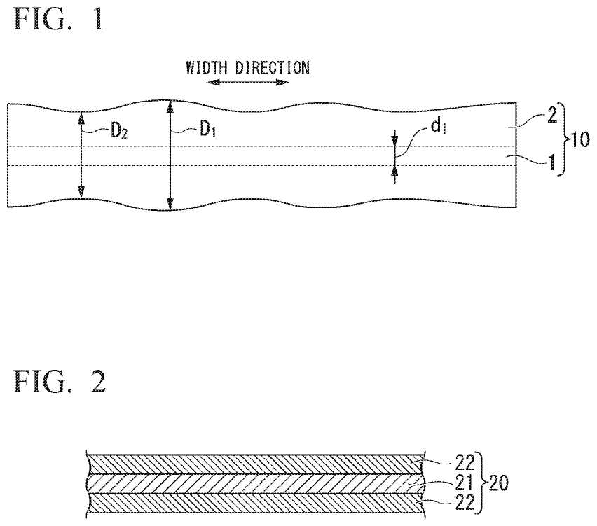

FIG. 1 is a schematic view for describing a film wound body of an embodiment.

A film wound body 10 shown in FIG. 1 is formed of a cylindrical core 1, and a polyolefin microporous film (hereinafter, may be referred to as a “porous film”) 2 wound around the core 1. The porous film 2 is used as a separator for a power storage device. The porous film 2 unwound from the film wound body 10 can be particularly suitably used as a separator of a lithium secondary battery.

In the film wound body 10 shown in FIG. 1, a difference ΔR between a maximum outer diameter D₁ and a minimum outer diameter D₂ in a width direction is in a range of 0.05 to 1.2 mm. In a case where the ΔR exceeds 1.2 mm, a tension applied to the porous film 2 becomes uneven, in a case of unwinding the porous film 2 from the film wound body 10. Accordingly, a strain of the porous film 2 caused by the unwinding of the porous film 2 is increased, and the slack amount of the porous film 2 unwound from the film wound body 10 cannot be sufficiently decreased. Therefore, the ΔR is set to be equal to or smaller than 1.2 mm and is preferably equal to or smaller than 1.0 mm. Meanwhile, in the film wound body 10 in which the ΔR is smaller than 0.05 mm, it is difficult to control the ΔR, in a case of winding the porous film 2, and it is difficult to form the porous film 2. Accordingly, the ΔR is set to be equal to or greater than 0.05 mm and is preferably equal to or greater than 0.1 mm.

The difference ΔR can be adjusted by a thickness adjustment mechanism of a film manufacturing device. Specifically, regarding a film molded from an inflation die or a T die, a thickness of the film can be adjusted by a lip heater of the film manufacturing device or a mechanism of adjusting a lip gap. In a case where the adjustment of the thickness of the film is not sufficient, a thickness unevenness occurs, and a value of ΔR of the film wound body 10 is hardly decreased. In a case where a period of time for the adjustment of the thickness of the film is excessively long, a yield of the film production is easily reduced.

In addition, it is also possible to adjust the thickness of the film in real time by using an in-line film thickness meter, but the value of ΔR of the film wound body 10, after the film is wound and overlapped, is not likely to become a desired numeral value. Accordingly, the value of ΔR is most easily adjusted, by a method of feeding back the value of ΔR of the wound film.

The width of the film wound body 10 can be suitably determined, is not particularly limited, and is preferably in a range of 10 to 5,000 mm. As the width of the film wound body 10 is narrow, the film wound body 10 having a small value of ΔR is easily obtained. In a case where the width of the film wound body 10 is equal to or smaller than 5,000 mm, the film wound body 10 having ΔR equal to or smaller than 1.2 mm is easily obtained.

The width of the film wound body 10 can be set as, for example, approximately 1,100 mm, approximately 650 mm, and the like. In addition, the film wound body 10 having a width of approximately 1,100 mm or approximately 650 mm may be set as a separator mother roll, and this may be trimmed (slit) to have a random width in a range of 60 mm to 300 mm to obtain a separator roll.

The core 1 of the film wound body 10 has a cylindrical shape.

As the core 1, a well-known component is used as the core of the film wound body 10. A material of the core 1 is not particularly limited, and, for example, a resin (polyethylene, polypropylene, vinyl chloride, an ABS resin, an epoxy resin, a polyester resin, butadiene rubber, polystyrene, a polyimide resin, a polyamide resin, a polyamideimide resin, an acrylic resin, polyvinyl chloride, polyvinylidene chloride, or a polyurethane resin), a paper, or the like. These can be used alone or in combination of two or more kinds thereof.

As the core 1, a high-strength core having a high rigidity, a dimension of which is hardly changed, is preferable. As the high-strength core, a core in which a cylindrical base material is formed of a fiber-reinforced resin is used. As the base material, a base material including a fiber-reinforced resin layer is used. Hereinafter, an example of the high-strength core will be described with a manufacturing method thereof.

First, a sheet-like glass fiber impregnated with a thermosetting resin such as an epoxy resin is wound around a mandrel (core bar), to form a sheet-like glass fiber-reinforced resin layer. Then, a thread-like glass fiber impregnated with a thermosetting resin such as an epoxy resin is wound around an outer peripheral surface of the sheet-like glass fiber-reinforced resin layer, to form a thread-like glass fiber-reinforced resin layer on the outer side of the sheet-like glass fiber-reinforced resin layer.

After heat curing the thermosetting resin, in a case where the mandrel is removed and the outer surface of the thread-like glass fiber-reinforced resin layer is smoothed by machining or grinding, a cylindrical base material made of the fiber-reinforced resin is completed. In the base material formed as described above, the inner surface is configured with the fiber-reinforced resin by the sheet-like glass fiber, and accordingly, the smoothness of the inner peripheral surface is sufficiently ensured.

The base material formed as described above is disposed in a die, a surface layer configured with a thermoplastic resin such as a polypropylene resin or the like is formed on the outer peripheral surface of the base material, to complete a high-strength core. As the surface layer, other resins, or a material other than the resin may be used, or in a case where the fiber-reinforced resin is used as the surface of the high-strength core, the formation of the surface layer may be omitted.

The high-strength core manufactured by doing so includes the fiber-reinforced resin layer formed of the sheet-like glass fiber-reinforced resin layer and the thread-like glass fiber-reinforced resin layer, and accordingly, is strongly protected by the fiber-reinforced resin.

Mainly, as the core for the separator mother roll, the high-strength core described above can be used, and as a core for the separator roll obtained by trimming the separator mother roll, a core including an outer cylindrical portion, an inner cylindrical portion, and a plurality of ribs obtained by extrusion molding can also be used.

As the core 1, a core having an even and thick outer diameter d₁ is preferably used. Specifically, the outer diameter d₁ of the core 1 is preferably equal to or greater than 76 mm (approximately 3 inches) to equal to or smaller than 254 mm (approximately 10 inches). In a case where the outer diameter of the core 1 is equal to or greater than 76 mm, the number of winding of the porous film 2 wound around the core may be small, even in a case where a total length of the porous film 2 is great. As a result, the outer diameter of the film wound body 10 becomes more even. The outer diameter of the core 1 is more preferably equal to or greater than 127 mm (approximately 5 inches) to equal to or smaller than 254 mm (approximately 10 inches) and even more preferably equal to or greater than 152 mm (approximately 6 inches) to equal to or smaller than 254 mm (approximately 10 inches), in order to decrease the number of winding.

On the other hand, in a case where the outer diameter d₁ of the core 1 is equal to or smaller than 254 mm (approximately 10 inches), the outer diameter of the film wound body 10 does not become excessively great, even in a case where the number of winding of the porous film 2 is great, due to a long total length of the porous film 2. Accordingly, it is easy to handle, transport, and store the film wound body 10.

In the film wound body 10 of the present embodiment, in a case where the outer diameter d₁ of the core 1 is equal to or greater than 3 inches, for example, the porous film 2 having a total length equal to or greater than 2,000 m is wound around the core 1, and the porous film 2 can be efficiently transported and stored.

In cases where the outer diameter d₁ of the core 1 is equal to or greater than 6 inches, for example, the porous film 2 having a total length equal to or greater than 4,000 m is wound around the core 1, and the porous film 2 can be efficiently transported and stored. The total length of the porous film 2 is preferably equal to or smaller than 10,000 m.

In the film wound body 10, the outer diameter d₁ of the core 1 is in a range of 86 to 96 mm, the number of winding of the porous film 2 is preferably equal to or greater than 3,500. In the film wound body 10, the outer diameter d₁ of the core 1 is in a range of 165 to 178 mm, the number of winding of the porous film 2 is preferably equal to or greater than 2,000.

In addition, the numbers of winding, in a case where the outer diameter d₁ of the core 1 is in the range of 86 to % mm or in the range of 165 to 178 mm, are respectively in the ranges described above, the physical properties (Gurley value or film thickness) of the porous film 2 unwound from the film wound body 10 is the same as those before being wound around the core 1.

Regarding the dimensions of the core 1, for example, the core having an inner diameter of 152 mm and an outer diameter in the range of 165 to 178 mm, and the core having an inner diameter of 76 mm and an outer diameter of 96 mm are preferably used. The dimension of the core 1 is not limited to these examples, and the core having a dimension suitable according to the purpose of the film wound body 10 may be used.

A difference between the maximum outer diameter and the minimum outer diameter of the core 1 in the width direction is preferably equal to or smaller than 0.5 mm.

In a case where the difference between outer diameters of the core 1 is equal to or smaller than 0.5 mm, a strain of the porous film 2 caused by the winding of the porous film 2 around the core 1 is easily reduced, and the outer diameter of the film wound body 10 becomes more even. However, it is difficult to obtain the core 1 having a difference between outer diameters smaller than 0.1 mm. In addition, even in a case where the core 1 having a difference between outer diameters smaller than 0.1 mm is used, the effect of causing the outer diameter of the film wound body 10 to become even is not improved. Therefore, the difference between outer diameters of the core 1 is preferably equal to or greater than 0.1 mm.

A width of the core 1 is not particularly limited and may be suitably determined in accordance with a width of the porous film 2. Specifically, the width of the core 1 may be the same as the width of the porous film 2 and may be slightly wider than the width of the porous film 2. In a case where the width of the core 1 is wider than the width of the porous film 2, it is possible to surely wind the porous film 2 around the core 1.

In the film wound body 10 of the present embodiment, the thickness of the porous film 2 is preferably equal to or greater than 2 μm and more preferably equal to or greater than 4 μm. In a case where the thickness of the porous film 2 is equal to or greater than 2 μm, for example, in a power storage device using the porous film 2 as a separator, it is possible to expect the effect of preventing short circuit between electrodes.

In addition, the thickness of the porous film 2 is preferably equal to or smaller than 35 μm and more preferably equal to or smaller than 25 μm. In a case where the thickness of the porous film 2 is equal to or smaller than 35 μm, for example, in the power storage device using the porous film 2 as a separator, it is possible to prevent a resistance increase due to the excessively great thickness of the porous film 2. Accordingly, in the power storage device using the porous film 2 as a separator, it is possible to decrease a percentage caused by the separator causing a resistance change.

A standard deviation of the thickness (unevenness of thickness) of the porous film 2 in the width direction (TD direction) is preferably equal to or smaller than 1 μm and more preferably equal to or smaller than 0.5 μm. In a case where the standard deviation of the thickness of the porous film 2 in the width direction is equal to or smaller than 1 μm, the film wound body 10 having a small ΔR is easily obtained. A lower limit value of the standard deviation of the thickness of the porous film 2 in the width direction is not particularly limited, and is preferably, for example, equal to or greater than 0.01 μm.

The standard deviation of the thickness of the porous film 2 in the width direction is obtained from measured values of the thicknesses on 10 or more portions which are obtained by measuring thicknesses of the porous film 2 in a width direction at random intervals.

A porosity of the porous film 2 is preferably equal to or more than 30% and more preferably equal to or more than 40%. In a case where the porosity of the porous film 2 is equal to or more than 30%, for example, in the power storage device using the porous film 2 as a separator, ionic conduction between electrodes is easily performed, and the effect of preventing an increase in impedance due to high-temperature storage is increased.

In addition, the porosity of the porous film 2 is preferably equal to or less than 70% and more preferably equal to or less than 60%. In a case where the porosity of the porous film 2 is equal to or less than 70%, it is possible to ensure a mechanical strength, and to effectively prevent the short circuit in the power storage device using the porous film 2 as a separator.

A surface roughness (Ra) of the porous film 2 is preferably equal to or greater than 0.01 μm to equal to or smaller than 0.30 μm, more preferably equal to or greater than 0.05 μm to equal to or smaller than 0.25 μm, and even more preferably equal to or greater than 0.05 μm to equal to or smaller than 0.23 μm. In a case where the porous film 2 having a great surface roughness is used as the separator and compressed in the thickness direction, the porous film 2 is easily crushed. The surface roughness of the porous film 2 is preferably equal to or greater than 0.01 μm, the manufacturing thereof is easily performed. The surface roughness of the porous film 2 is preferably equal to or smaller than 0.30 μm, because the porous film 2 is hardly crushed, even in a case where the porous film 2 is compressed in the thickness direction.

The surface roughness of the porous film 2 is obtained as follows.

An image on a surface (one surface) of the porous film 2 in a range of a length direction (MD direction) of 1.270 μm and a width direction (TD direction) of 960 μm is collected using a white interferometer (Vertscan 3.0) manufactured by Ryoka Systems Inc. under the condition of an object lens at 5 magnification. By performing linear analysis regarding any two portions of the collected image in the MD direction, the surface roughness (Ra) is obtained. The surface roughness of the porous film 2 is obtained regarding a rear surface (the other surface) of the porous film 2.

The porous film 2 may be any of a non-stretched film, a uniaxially stretched film, and a biaxially stretched flint. Since the slack amount of the unwound porous film 2 is small, the porous film 2 is preferably a uniaxially stretched film by a dry method.

As the porous film 2, for example, a porous film formed of polyethylene (PE), polypropylene (PP), an ethylene-propylene copolymer, or a mixture of these polyolefin resins is used. The porous film 2 preferably contains polyethylene (PE) and/or polypropylene (PP).

The weight average molecular weight of polypropylene contained in the porous film 2 is preferably equal to or greater than 500,000. In a case where the weight average molecular weight thereof is equal to or greater than 500,000, the strength in the film thickness direction is further increased, and accordingly, for example, even in a case where the porous film having a total length equal to or greater than 2,000 m is wound around the core, it is possible to maintain physical properties of the separator such as a permeability resistance (Gurley value) or porosity. The weight average molecular weight of polypropylene is preferably equal to or smaller than 800,000.

The weight average molecular weight of polypropylene can be obtained by gel permeation chromatography (GPC) using polystyrene as a standard substance.

In addition, the molecular weight distribution of polypropylene is preferably in a range of 9 to 13 and more preferably in a range of 9.5 to 13. In a case where the molecular weight distribution thereof is in the range described above, shape stability is further increased, and for example, a shrinkage factor at 40° C. circumstance can be further decreased.

The molecular weight distribution of polypropylene can be obtained by GPC using polystyrene as a standard substance.

In a case where the weight average molecular weight of polypropylene contained in the porous film 2 is in a range of 500,000 to 800,000 and the molecular weight distribution thereof is in the range of 9 to 13, stability of lamellar crystal of polypropylene is high, and accordingly, the porous film 2 having a reduced thickness unevenness is obtained. Therefore, the film wound body 10 having a small ΔR is easily obtained.

The weight average molecular weight of polyethylene contained in the porous film 2 is preferably in a range of 350,000 to 400,000.

In a case where the porous film 2 contains one or both of polypropylene having the weight average molecular weight in a range of 500,000 to 800,000 and polyethylene having the weight average molecular weight of in a range of 350,000 to 400,000, the slack amount of the unwound porous film 2 is further decreased. The reason for this is not completely determined, and for example, it is assumed that this is because the rigidity of the porous film is improved and a strain caused by the unwinding of the porous film is prevented, by comparing with a case of using a polypropylene porous membrane having a low molecular weight as the porous film.

The weight average molecular weight of polyethylene can be obtained by the same method as the weight average molecular weight of polypropylene.

The porous film 2 may be a single-layer film or a multilayer film. In a case where the porous film 2 is a multilayer film, it is preferable that polypropylene having a molecular weight of in the range of 500,000 to 800,000 and polyethylene having a molecular weight of in the range of 350,000 to 400,000 are laminated on each other. Here, the molecular weight indicates the weight average molecular weight.

FIG. 2 is a schematic cross-sectional view for describing an example of the porous film 2 formed of a multilayer film. The porous film 2 shown in FIG. 2 is formed of a multilayer film in which a polypropylene microporous membrane 22, a polyethylene microporous membrane 21, and the polypropylene microporous membrane 22 are laminated in this order.

In a case where the porous film 2 is the multilayer film in which the polypropylene microporous membrane 22, the polyethylene microporous membrane 21, and the polypropylene microporous membrane 22 are laminated in this order, the compressive elastic modulus of the porous film 2 is preferably in a range of 95 to 150 MPa, more preferably in a range of 100 to 140 MPa, and even more preferably in a range of 105 to 130 MPa. In a case where the compressive elastic modulus of the multilayer film is in the range of 95 to 150 MPa the porous film 2 unwound from the film wound body 10 easily maintains the shape before being wound around the core 1. In a case where the unwound porous film 2 maintains the shape before being wound, the winding of the porous film 2 around the core 1 and the unwinding thereof after that does not affect the physical properties regarding the shape of the porous film 2 such as the film thickness or permeability resistance of the porous film 2. Specifically, in a case where the compressive elastic modulus of the multilayer film is in the range of 95 to 150 MPa and the total length of the porous film 2 is equal to or smaller than 10,000 m, the physical properties regarding the shape of the porous film 2 are not negatively affected, even in a case where the porous film 2 is wound around and then unwound from the core 1. In addition, in a case where the compressive elastic modulus of the multilayer film is in the range of 95 to 150 MPa and the total length of the porous film 2 is equal to or smaller than 4,000 m, the shape of the porous film 2 is not crushed at all and maintained.

In the film wound body 10 of the present embodiment, the total length of the porous film 2 is preferably equal to or greater than 2,000 m and more preferably equal to or greater than 4,000 m. In a case where the total length of the porous film 2 is equal to or greater than 2,000 m, the porous film 2 can be efficiently transported and stored, by comparing with a case where the total length of the porous film 2 is smaller than 2,000 m. On the other hand, in a case where the total length of the porous film 2 is greater than 10,000 m, for example, the weight of the film wound body 10 increases and ease of handling (convenience) is deteriorated. Accordingly, the total length of the porous film 2 is preferably equal to or smaller than 10,000 m and more preferably equal to or smaller than 8,000 m.

As a result of intensive studies of the present inventors, in a separator roll of the related art, as the total length of the porous film to be wound around the core is long, or as the number of winding of the porous film is great, the slack amount of the porous film unwound from the separator roll tends to increase.

Particularly, in a case of winding the porous film having a total length equal to or greater than 2,000 m around the core to form the separator roll, without controlling the ΔR, the slack amount of the porous film unwound from the obtained separator roll easily becomes significantly great.

In contrast, in the film wound body 10 of the present embodiment in which the difference ΔR between the maximum outer diameter D₁ and minimum outer diameter D₂ in the width direction is in a range of 0.05 to 1.2 mm, the slack amount of the unwound porous film can be sufficiently decreased, even in a case where the total length of the porous film 2 is set as 2,000 m. In addition, in the film wound body 10 of the present embodiment, the slack amount of the unwound porous film 2 can be sufficiently decreased, even in a case where the total length of the porous film 2 is set as 4,000 m.

In addition, in the film wound body 10 of the present embodiment, the difference ΔR between the maximum outer diameter D₁ and minimum outer diameter D₂ in the width direction is in the range of 0.05 to 1.2 mm, and accordingly, the slack amount of the unwound porous film 2 is sufficiently small, even in a case where the number of winding of the porous film 2 is increased to increase the length thereof.

In the film wound body 10 of the present embodiment, by devising the winding method of the porous film 2, the difference ΔR between the maximum outer diameter D₁ and minimum outer diameter D₂ in the width direction can be in the range of 0.05 to 1.2 mm.

Next, the method of manufacturing the film wound body of the present embodiment will be described in detail.

In order to manufacture the film wound body 10 of the present embodiment, first, a film roll used as a base material is prepared. The film roll is formed of a cylindrical core and an original fabric film wound around the core. The original fabric film is formed with a base material to be the porous film 2 of the film wound body 10, by stretching the original fabric film and making pores.

In the present embodiment, a film roll in which the difference ΔR between the maximum outer diameter D₁ and minimum outer diameter D₂ in the width direction is in a range of 0.1 to 1.8 mm is preferably used. In a case where the ΔR of the film roll is equal to or smaller than 1.8 mm, a strain of the original fabric film caused by the unwinding of the original fabric film is small, and accordingly, a porous film having a small quality difference caused by a porosity step and a winding step which will be described later is obtained. As a result, the film wound body 10 having a small ΔR is easily obtained. Accordingly, the ΔR of the film roll is preferably equal to or smaller than 1.8 mm and more preferably equal to or smaller than 1.0 mm. Meanwhile, the film roll having the ΔR smaller than 0.1 mm is hardly obtained, and the effect of decreasing the ΔR of the film wound body 10 manufactured by using this is not improved, even in a case where the ΔR is smaller than 0.1 mm. Therefore, the ΔR of the film roll is preferably equal to or greater than 0.1 mm and more preferably equal to or greater than 0.2 mm.

In the present embodiment, the original fabric film of the film roll preferably contains any one or both of polypropylene having the weight average molecular weight in the range of 500,000 to 800,000 and polyethylene having the weight average molecular weight in the range of 350,000 to 400,000. The film wound body 10 manufactured by using the film roll easily has the small ΔR. The reason for this is not clear, and, for example, it is assumed that this is because that the rigidity of the original fabric film is improved and a strain caused by the unwinding of the original fabric film is prevented, by comparing with a case of using a polypropylene membrane having a low molecular weight as the original fabric film.

The core of the film roll has a cylindrical shape. As the core of the film roll, a well-known core can be used. As the core of the film roll, a core having an even and thick outer diameter is preferably used, in the same manner as the core 1 of the film wound body 10.

Next, a porosity step of stretching the original fabric film unwound from the film roll or the laminated film on which two or more layers of the original fabric films are laminated, and making pores, to obtain the porous film 2 is performed.

In a case of manufacturing the film wound body 10 in which the porous film 2 is a multilayer film, by the manufacturing method of the present embodiment, a laminated film on which two or more layers of the original fabric films are laminated is formed, before stretching in the porosity step. The laminated film is obtained by a method of performing thermal compression bonding (lamination) of the original fabric film on which two or more layers are laminated. The temperature in the thermal compression bonding is set as a temperature exceeding a melting point of the laminated original fabric film and is determined in accordance with the kind of the laminated original fabric film.

The original fabric film or the laminated film is preferably stretched and have pores by the method shown below. First, the original fabric film or the laminated film before the stretching is heated in a temperature range of 110° C. to 150° C. The heat treatment temperature is more suitably equal to or greater than 115° C. to equal to or smaller than 140° C.

Next, the original fabric film or the laminated film after the heat treatment is stretched at a low temperature in a cold stretching zone. The temperature in the low-temperature stretching is preferably equal to or greater than negative 20° C. to equal to or smaller than positive 50° C. and particularly preferably equal to or greater than 20° C. to equal to or smaller than 40° C. The excessively low temperature of the low-temperature stretching is not preferable, because the fracture of the film easily occurs in handling the film. On the other hand, the excessively high temperature of the low-temperature stretching is not preferable, because the porosity step is not sufficiently performed. The ratio of the low-temperature stretching (initial stretching ratio) is preferably equal to or greater than 3% to equal to or smaller than 200% and more preferably equal to or greater than 5% to equal to or smaller than 100%. In a case where the ratio of the low-temperature stretching is equal to or more than 3%, the porous film 2 having a sufficiently high porosity is easily obtained. In addition, in a case where the ratio of the low-temperature stretching is equal to or less than 200%, the porous film 2 having predetermined porosity and hole diameter is easily obtained.

Next, the original fabric film or the laminated film after the low-temperature stretching is stretched at a high temperature in a hot stretching zone. The temperature in the high-temperature stretching is preferably equal to or greater than 70° C. to equal to or smaller than 150° C. and particularly preferably equal to or greater than 80° C. to equal to or smaller than 145° C. A ratio of the high-temperature stretching (maximum stretching ratio) is preferably equal to or greater than 100% to equal to or smaller than 400%. In a case where the ratio of the high-temperature stretching is excessively low, a gas permeability of the porous film 2 may be insufficient. In addition, in a case where the ratio of the high-temperature stretching is excessively high, the gas permeability of the porous film 2 may be excessively high.

In the present embodiment, the original fabric film or the laminated film after the heat treatment is low-temperature stretched in the cold stretching zone, high-temperature stretched in the hot stretching zone to make pores, and a laminated porous film is obtained. In a case of manufacturing a polyolefin microporous membrane in which a polypropylene microporous membrane and a polyethylene microporous membrane are laminated, the pores of laminated film of the polypropylene membrane and the polyethylene membrane are not sufficiently obtained, only by any one of the low-temperature stretching and the high-temperature stretching, and properties in a case of using the manufactured porous film 2 as a separator for a battery are deteriorated.

In the present embodiment, the low-temperature stretching and the high-temperature stretching are preferably uniaxial stretching.

After the high-temperature stretching, the heat treatment is performed at a temperature higher than the temperature in the high-temperature stretching by 5° C. to 45° C. By doing so, the porous film 2 is obtained.

Next, a winding step of winding the porous film 2 around the core 1 is performed. The method of winding the porous film 2 around the core 1 is not particularly limited, and the winding can be performed by a well-known method of the related art, by suitably controlling the winding condition so that the difference ΔR between the maximum outer diameter D₁ and minimum outer diameter D₂ in the width direction is in the range of 0.05 to 1.2 mm.

By the steps described above, the film wound body 10 of the present embodiment is obtained.

In the film wound body 10 of the present embodiment, the difference ΔR between the maximum outer diameter D₁ and minimum outer diameter D₂ in the width direction is in the range of 0.05 to 1.2 mm. Accordingly, a strain of the porous film 2 caused by the unwinding of the porous film 2 is small and the slack amount of the porous film 2 unwound from the film wound body 10 is small. Therefore, the porous film 2 unwound from the film wound body 10 of the present embodiment has suitable winding properties and handling properties, in a case of manufacturing a lithium secondary battery using this as a separator. In addition, since the slack amount of the porous film 2 unwound from the film wound body 10 of the present embodiment is small, the porous film 2 unwound from the film wound body 10 of the present embodiment is suitable as a separator of a stack type battery.

Since the difference ΔR between the maximum outer diameter and minimum outer diameter in the width direction is in a range of 0.1 to 1.8 mm, the film roll of the present embodiment is suitable as a base material of the film wound body 10 of the present embodiment.

### EXAMPLES

Hereinafter, the specific examples of the present invention will be described. The present invention is not only limited to these examples.

An original fabric film unwound from an original fabric roll (film roll) shown in Table 1 was laminated and thermal compression-bonded (lamination) so as to obtain a layer structure of the porous film (separator) shown in Table 1, and a laminated film was obtained. Next, the obtained laminated film was heated at a range of equal to or greater than 110° C. to equal to or smaller than 150° C.

Next, the original fabric film or the laminated film after the heat treatment was uniaxially stretched at a temperature of equal to or greater than 20° C. to equal to or smaller than 40° C. in a cold stretching zone at a ratio of equal to or greater than 5% to equal to or smaller than 100% (low-temperature stretching).

Then, the laminated film after the low-temperature stretching was uniaxially stretched at a temperature of equal to or greater than 80° C. to equal to or smaller than 145° C. in a hot stretching zone at a ratio of equal to or greater than 100% to equal to or smaller than 400% (high-temperature stretching).

After that, the heat treatment was performed at a temperature higher than the temperature in the second stretching by 5° C. to 45° C. and a porous film was obtained. Then, the porous film was wound around a side surface of the core formed in a cylindrical shape having an outer diameter shown in Table 1 by the number of winding shown in Table 1, and film wound bodies of Examples 1 to 10 and Comparative Examples 1 and 2 were obtained. A difference between a maximum outer diameter and a minimum outer diameter of all of the cores in a width direction used in Examples 1 to 10 and Comparative Examples 1 and 2 was in a range of 0.1 to 0.5 mm.

TABLE 1

| | | Example 1 | Example 2 | Example 3 | Example 4 |
|---|---|---|---|---|---|
| Original | PP molecular weight | 550,000-750,000 | 550,000-750,000 | 550,000-750,000 | 550,000-750,000 |
| fabric | PE molecular weight | 390000 | 390000 | 390000 | 390000 |
| Original | Total length (m) | 20000 | 13500 | 19800 | 19800 |
| fabric roll | Total width (mm) | 1315 | 1315 | 1315 | 1315 |
| (PPA) | Number of winding | 20509 | 15576 | 20369 | 20369 |
| | (times) | | | | |
| | Roll outer diameter (mm) | 454 | 385 | 452 | 452 |
| | ΔR (mm) | 0.5 | 0.4 | 0.3 | 0.3 |
| Original | Total length (m) | 20000 | 13500 | 19800 | 9900 |
| fabric roll | Total width (mm) | 1315 | 1315 | 1315 | 1315 |
| (PPA) | Number of winding | 20509 | 15576 | 20369 | 12417 |
| | (times) | | | | |
| | Roll outer diameter (mm) | 454 | 385 | 452 | 341 |
| | ΔR (mm) | 0.3 | 0.2 | 0.2 | 0.2 |
| Original | Total length (m) | 20000 | 13500 | 19800 | 19800 |
| fabric roll | Total width (mm) | 1280 | 1280 | 1280 | 1280 |
| (PE) | Number of winding | 19489 | 14877 | 19358 | 19358 |
| | (times) | | | | |
| | Roll outer diameter (mm) | 487 | 411 | 484 | 484 |
| | ΔR (mm) | 0.7 | 0.3 | 0.6 | 0.3 |
| Separator | Layer structure | PEP 3 layer | PEP 3 layer | PEP 3 layer | PEP 3 layer |
| | Film thickness (μm) | 17.8 | 17.7 | 18.5 | 18.3 |
| | Porosity (%) | 51.1 | 49.75 | 51.2 | 51.1 |
| Film wound | Total length (m) | 6600 | 7500 | 7650 | 7650 |
| body | Total width (mm) | 1108 | 1100 | 1115 | 1115 |
| | Core outer diameter (mm) | 167 | 167 | 167 | 167 |
| | Number of winding | 7121 | 7779 | 7779 | 7851 |
| | (times) | | | | |
| | Roll outer diameter (mm) | 423 | 447 | 451 | 451 |
| | ΔR (mm) | 0.5 | 0.4 | 0.3 | 0.3 |
| Slack amount | | A | A | A | A |
| | | Example 5 | Example 6 | Example 7 | Example 8 |
| Original | PP molecular weight | 550,000-750,000 | 550,000-750,000 | 550,000-750,000 | 550,000-750,000 |
| fabric | PE molecular weight | 390000 | — | 390000 | 390000 |
| Original | Total length (m) | 18600 | 9400 | 9400 | 20000 |
| fabric roll | Total width (mm) | 1315 | 860 | 860 | 860 |
| (PPA) | Number of winding | 19512 | 9613 | 16564 | 20327 |
| | (times) | | | | |
| | Roll outer diameter (mm) | 440 | 350 | 278 | 460 |
| | ΔR (mm) | 0.3 | — | 0.7 | 1.1 |
| Original | Total length (m) | 18600 | 9400 | 9400 | 20000 |
| fabric roll | Total width (mm) | 1315 | 860 | 860 | 860 |
| (PPA) | Number of winding | 19512 | 9613 | 16564 | 20327 |
| | (times) | | | | |
| | Roll outer diameter (mm) | 440 | 350 | 278 | 460 |
| | ΔR (mm) | — | — | 0.7 | 0.9 |
| Original | Total length (m) | 18600 | — | 9400 | 20000 |
| fabric roll | Total width (mm) | 1280 | — | 840 | 840 |
| (PE) | Number of winding | 18559 | — | 15124 | 17585 |
| | (times) | | | | |
| | Roll outer diameter (mm) | 471 | — | 313 | 557 |
| | ΔR (mm) | 0.5 | — | 0.6 | 0.7 |
| Separator | Layer structure | PEP 3 layer | PP single layer | PEP 3 layer | PEP 3 layer |
| | Film thickness (μm) | 18.3 | 15.6 | 16.2 | 21.1 |
| | Porosity (%) | 50.2 | 56.5 | 49.8 | 49.2 |
| Film wound | Total length (m) | 7070 | 1700 | 2400 | 6200 |
| body | Total width (mm) | 1108 | 700 | 692 | 683 |
| | Core outer diameter (mm) | 167 | 176 | 167 | 167 |
| | Number of winding | 7851 | 2596 | 3325 | 6494 |
| | (times) | | | | |
| | Roll outer diameter (mm) | 436 | 250 | 284 | 441 |
| | ΔR (mm) | 0.3 | 1.2 | 0.8 | 0.7 |
| Slack amount | | A | A | A | A |
| | | | | Comparative | Comparative |
| | | Example 9 | Example 10 | Example 1 | Example 2 |
| Original | PP molecular weight | 550,000-750,000 | 550,000-750,000 | 380,000-490,000 | 380,000-490,000 |
| fabric | PE molecular weight | 390000 | 390000 | 390000 | 390000 |
| Original | Total length (m) | 20000 | 17000 | 20000 | 20000 |
| fabric roll | Total width (mm) | 860 | 870 | 1375 | 1375 |
| (PPA) | Number of winding | 17698 | 14549 | 20238 | 20238 |
| | (times) | | | | |
| | Roll outer diameter (mm) | 553 | 577 | 462 | 462 |
| | ΔR (mm) | 1.1 | 1.1 | 1.9 | 1.4 |
| Original | Total length (m) | 20000 | 17000 | 20000 | 20000 |
| fabric roll | Total width (mm) | 860 | 870 | 1375 | 1375 |
| (PPA) | Number of winding | 17698 | 14549 | 20238 | 20238 |
| | (times) | | | | |
| | Roll outer diameter (mm) | 553 | 577 | 462 | 462 |
| | ΔR (mm) | 1.2 | 1.1 | 1.9 | 1.4 |
| Original | Total length (m) | 20000 | 17000 | 20000 | 20000 |
| fabric roll | Total width (mm) | 840 | 840 | 1340 | 1340 |
| (PE) | Number of winding | 18622 | 17876 | 18897 | 18897 |
| | (times) | | | | |
| | Roll outer diameter (mm) | 517 | 439 | 507 | 507 |
| | ΔR (mm) | 0.7 | 1.0 | 1.0 | 1.5 |
| Separator | Layer structure | PEP 3 layer | PEP 3 layer | PEP 3 layer | PEP 3 layer |
| | Film thickness (μm) | 26.2 | 29.9 | 18.7 | 18.6 |
| | Porosity (%) | 48.6 | 49.6 | 45.4 | 45.3 |
| Film wound | Total length (m) | 6200 | 5000 | 7600 | 7600 |
| body | Total width (mm) | 690 | 690 | 1130 | 1130 |
| | Core outer diameter (mm) | 167 | 67 | 167 | 167 |
| | Number of winding | 6061 | 5021 | 7770 | 7770 |
| | (times) | | | | |
| | Roll outer diameter (mm) | 485 | 467 | 456 | 456 |
| | ΔR (mm) | 0.8 | 1.2 | 1.4 | 1.3 |

| | | | | |
|---|---|---|---|---|
| Slack amount | A | A | B | B |

The original fabric film (PPA) or (PPB) is formed of polypropylene having a PP molecular weight shown in Table 1. In addition, the original fabric film (PE) is formed of polyethylene having a PE molecular weight shown in Table 1.

The molecular weight distribution of PP is in a range of 9.5 to 13 in all examples and is equal to or smaller than 9.3 in all comparative examples.

“PEP 3 layer” in the column of the layer structure of the porous film of Table 1 means a porous film having a three-layer structure in which a polypropylene microporous membrane, a polyethylene microporous membrane, and a polypropylene microporous membrane are laminated in this order. “PP single layer” in the column of the layer structure of the porous film means a polypropylene porous film having a single-layer structure formed by laminating and thermal compression bonding of two polypropylene membranes.

The film thickness and the porosity of the separator (porous film) shown in Table 1 were obtained by the following method.

[Film Thickness Measurement]

Five tape-shaped test pieces having a length in a length direction (MD direction) over the entire width were prepared. The five test pieces were overlapped, thicknesses were measured at regular intervals so that measurement points were 25 points, by using an electric micrometer manufactured by Finepreuf Co., Ltd. (Millitron 1240 stylus 5 mmϕ (flat surface, stylus pressure: 0.75 N)), and an average value thereof was set as a film thickness.

[Porosity Measurement]

Two test pieces having a size of 100 mm×100 mm were collected along both end surfaces of both end portions of a sample in a width direction by using a mold. A weight of each of the two collected test pieces was measured to be 0.1 mg. A porosity was calculated from the measured weight by using the following equation. The result was calculated with the first decimal place, by rounding off to the first decimal places and

Porosity (%)=[1−{w/(L1×L2×t)×ρ}]×100
w: weight of test piece (g)
L1: vertical length of test piece (cm)
L2: horizontal length of test piece (cm)
t: thickness of test piece (cm)
ρ: density of test piece (g/cm³)

[Weight Average Molecular Weight and Molecular Weight Distribution]

The weight average molecular weight and the molecular weight distribution of polyethylene and polypropylene using an original fabric roll as a raw material were obtained by standard polystyrene conversion by using a V200 type gel permeation chromatograph manufactured by Waters Corporation. Two ShodexAT-G+AT806MS (manufactured by Showa Denko K. K.) were used as a column, the measurement was performed in orthodichlorobenzene having a concentration adjusted to 0.3 wt/vol % at 145° C. For a detector, a differential refractometer (RI) was used.

[Compressive Elastic Modulus]

A plurality of sample pieces having a size of 50 mm×50 mm were collected from the separator and laminated, and samples having a thickness of 5 mm were obtained. A metal cylinder having a diameter of 10 mm was pressed against the obtained sample, and a stress-strain curve in a compression direction was drawn by using 500 N load cell by ORIENTEC. RTC-1250A under the condition of a chuck crosshead speed of 0.5 mm/min. The compressive elastic modulus was calculated from an inclination of a portion where the inclination of the stress-stain curve became constant.

Here, the stress is a compressive load (N) per unit area (mm²) (=stress of compression (N/mm²)) and the unit is MPa. For example, a stress, in a case where a load of 100 N is applied with a metal cylinder having a diameter of 10 mm, is 100 N/(5 mm×5 mm×π)≈1.27 MPa. The stain is a value obtained by dividing a displacement amount of the deformation in a case where the stress of compression is applied, by an initial thickness (5 mm) and no unit is used. For example, in a case where there is deformation to 4.8 mm from 5 mm which is the initial thickness by the test, the displacement amount is 0.2 mm and the stain amount is 0.2 mm/5 mm=0.04.

By the method described above, regarding the separators of Examples 1 to 10 and Comparative Examples 1 and 2 in which the layer structure shown in Table 1 is PEP 3 layer, the compressive elastic modulus was measured. As a result, regarding all of the separator, the compressive elastic modulus was in a range of 105 to 130 MPa.

[Outer Diameter and ΔR]

An outer diameter and ΔR of the original fabric roll and the film wound body shown in Table 1 were obtained by the following method. That is, an outer diameter of a roll was measured continuously over the entire width along a width direction (TD direction) by using an original fabric measurer manufactured by Hamano Precision Instrument CO. Ltd. Specifically, the measurement was performed by bringing a linear gauge which is a detector of the measurer into contact with a roll surface to cause running on an exclusive rail at a speed of 12.5 mm/sec. The data from the linear gauge was collected as digital data by using a digital recorder at interval of 0.1 seconds. An average value was calculated by using the measured values and set as the outer diameter. In addition, a difference ΔR between a maximum outer diameter and a minimum outer diameter in a width direction was calculated by using the measured values.

As shown in Table 1, in a case where the ΔR of the original fabric roll was equal to or smaller than 1.2 mm, the ΔR of film wound body was equal to or smaller than 1.2 mm.

[Slack Amount]

The slack amount of the porous film unwound from the separator roll trimmed to have a width of approximately 100 mm and a length equal to or greater than 2.000 m from the film wound body (separator mother roll) shown in Table 1 was calculated by the method shown below.

Two metal rolls were arranged in parallel with an interval (roll axis interval: 700 mm). A length direction of the porous film and an axis direction of the two metal rolls are set to be orthogonal to each other, the porous film was installed so as to straddle the two metal rolls, and both ends of the porous film in the length direction were grasped.

Then, a load was applied to the porous film, and the slack amount generated due to the applying of the load was measured by a laser displacement meter.

A case where the slack amount is equal to or smaller than 10 mm was evaluated as pass (A) and a case where the slack amount exceeds 10 mm was evaluated as failure (B). The evaluation result thereof was shown in Table 1.

In addition, regarding the porous film in which the film width is smaller than 100 mm or equal to or greater than 100 mm to equal to or smaller than 300 mm, the measurement was performed in the same manner, and as the slack amount, a numerical value obtained by standardizing 10 mm which is a threshold value in a case where the film width is 100 mm as the film width was used.

For example, in a case of a product having a film width of 200 mm, the slack amount equal to or smaller than 20 mm was evaluated as pass, in a case of a product having a film width of 300 mm, the slack amount equal to or smaller than 30 mm was evaluated as pass, and in a case of a product having a film width of 60 mm, the slack amount equal to or smaller than 6 mm was evaluated as pass.

As shown in Table 1, in all of the film wound bodies of Examples 1 to 10, the evaluation of the slack amount was (A).

In contrast, in the film wound bodies of Comparative Examples 1 and 2 in which the difference ΔR between the maximum outer diameter Dt and minimum outer diameter D₂ in the width direction exceeded 1.2 mm, the evaluation of the slack amount was (B).

### REFERENCE SIGNS LIST

10: film wound body
1: core
2: porous film (polyolefin microporous film)
21: polyethylene microporous membrane
22: polypropylene microporous membrane
D₁: maximum outer diameter in width direction
D₂: minimum outer diameter in width direction

1. A film wound body formed of:
a cylindrical core; and
a polyolefin microporous film which is wound around the core and used as a separator for a power storage device,
wherein a difference ΔR between a maximum outer diameter and a minimum outer diameter in a width direction is in a range of 0.05 to 1.2 mm.

2. The film wound body according to claim 1, wherein the polyolefin microporous film includes one or both of polypropylene and polyethylene.

3. The film wound body according to claim 1, wherein the polyolefin microporous film has a three-layer structure in which a polypropylene microporous membrane, a polyethylene microporous membrane, and a polypropylene microporous membrane are laminated in this order.

4. The film wound body according to claim 1,
wherein a compressive elastic modulus of the polyolefin microporous film is in a range of 95 MPa to 150 MPa.

5. The film wound body according to claim 2,
wherein the polyolefin microporous film includes polypropylene, and a weight average molecular weight of the polypropylene is equal to or greater than 500,000.

6. The film wound body according to claim 2,
wherein the polyolefin microporous film includes polypropylene, and a molecular weight distribution of the polypropylene is in a range of 9 to 13.

7. The film wound body according to claim 1,
wherein a total length of the polyolefin microporous film is equal to or greater than 2,000 m.
